(19) United States
(12) Patent Application Publication
(10) Pub. No.: US 2017/0121536 A1
(43) Pub. Date: May 4, 2017

(54) INSULATION-LAYER-FORMING COMPOSITION AND USE THEREOF

(71) Applicant: HILTI AKTIENGESELLSCHAFT, Schaan (LI)

(72) Inventors: Juliane MARAUSKA, Kaltenkirchen (DE); Jekaterina JEROMENOK, Augsburg (DE); Martin LANG, Planegg (DE); Sebastian SIMON, Buchloe Lindenberg (DE)

(73) Assignee: HILTI AKTIENGESELLSCHAFT, Schaan (LI)

(21) Appl. No.: 15/318,184

(22) PCT Filed: Jun. 10, 2015
(86) PCT No.: PCT/EP2015/062876

§ 371 Date: Dec. 12, 2016

(30) Foreign Application Priority Data
Jun. 11, 2014 (EP) 14171878.3

(51) Int. Cl. C09D 5/18; C08K 5/00; C09D 183/08; C08K 3/00

(52) U.S. Cl. CPC C09D 5/185; C08K 3/0058; C08K 5/0066; C09D 183/08

(57) ABSTRACT

An insulation-layer-forming composition is described, which contains a binder on the basis of an alkoxysilane-functionalized polymer, which carries alkoxy-functionalized silane groups, an insulation-layer-forming additive, and, if applicable, a crosslinking agent. By means of the composition according to the invention, the expansion rate of which is relatively high, coatings having the layer thickness required for the respective fire-resistance duration can be applied in simple and rapid manner, wherein the layer thickness can be reduced to a minimum and nevertheless, a great insulating effect can be achieved. The composition according to the invention is particularly suitable for fire-protection, particularly as a coating for steel structural parts, such as supports, beams, frame members, to increase their fire-resistance duration.

The present invention relates to an insulation-layer-forming composition, particularly two-component or multi-component composition having intumescent properties, which contains a binder on the basis of an alkoxysilane-functionalized polymer, which contains alkoxy-functionalized silane groups, as well as use thereof for fire protection, particularly for coatings of structural parts such as supports, beams or frame members, to increase their fire-resistance duration.

Insulation-layer-forming compositions, also called intumescent compositions, are usually applied to the surface of structural parts for the formation of coatings, in order to protect these parts from fire or from a strong heat effect, such as that occurring as the result of a fire. In the meantime, steel constructions have become a fixed constituent of modern architecture, even though they have a decisive disadvantage in comparison with reinforced concrete construction. Above about 500° C., the load-carrying capacity of steel drops by 50%, i.e. the steel loses its stability and its carrying capacity. This temperature can already be reached after approximately 5-10 minutes, depending on the fire load, for example in the case of a direct fire effect (approximately 1000° C.), and this frequently leads to a loss of carrying capacity of the construction. It is now the goal of fire protection, particularly of steel fire protection, to delay the time span until loss of carrying capacity of a steel construction in the event of a fire as long as possible, in order to save lives and valuable property.

In this regard, corresponding fire-resistance times for specific structures built of steel are required in the building codes of many countries. They are defined by what are called F classes such as F 30, F 60, F 90 (fire-resistance classes according to DIN 4102-2) or American classes according to ASTM, etc. In this regard, F 30 according to DIN 4102-2, for example, means that a supporting steel construction must, in the event of a fire, withstand the fire for at least 30 minutes under standard conditions. This is usually achieved in that the heat-up speed of the steel is delayed, for example by covering the steel construction with insulation-layer-forming coatings. These are brushed-on coatings, the constituents of which foam up in the event of a fire, forming a solid, micro-porous carbon foam. During this process, a fine-pore and thick foam layer is formed, called an ash crust, which, depending on its composition, is strongly heat-insulating and therefore delays heating-up of the structural part, so that the critical temperature of approximately 500° C. is reached, at the earliest, after 30, 60, 90, 120 minutes or up to 240 minutes. The applied layer thickness of the coating, i.e. the ash crust that develops from it, is always essential for the fire resistance that can be achieved. Closed profiles, such as pipes, require about twice the amount as compared with open profiles, such as beams having a double-T profile, at comparable solidity. In order for the required fire-resistance times to be adhered to, the coatings must have a certain thickness, and must have the ability, when heat acts on them, to form the most voluminous possible and therefore well insulating ash crust, which remains mechanically stable over the time period of fire stress.

Various systems for this purpose exist in the state of the art. Essentially, a distinction is made between 100% systems and solvent-based or water-based systems. In the solvent-based or water-based systems, binders, generally resins, are applied to the structural part as a solution, dispersion or emulsion. These can be structured as single-component or multi-component systems. After application, the solvent or the water evaporates and leaves a film that dries over time. In this regard, a distinction can furthermore be made between those systems in which the coating essentially does not change any longer during drying, and those systems in which, after evaporation, the binder cures primarily by means of oxidation reactions and polymerization reactions, which are induced, for example, by means of oxygen. The 100% systems contain the constituents of the binder without solvent or water. They are applied to the structural part, wherein “drying” of the coating takes place merely by reaction of the binder constituents with one another.

The systems on the basis of solvent or water have the disadvantage that the drying times, also called curing times, are long, and furthermore, that multiple layers must be applied, in other words multiple work steps are needed to achieve the required layer thickness. Because each individual layer must be dried appropriately, before application of the next layer, this leads, for one thing, to a great expenditure of working time and accordingly, to high costs of completion of the structure, because depending on climatic conditions, in some cases several days elapse until the required layer thickness has been applied. It is furthermore disadvantageous that due to the required layer thickness, the coating can tend to form cracks and to flake off while drying or under the effect of heat, and therefore, in the worst case, the substrate is partly exposed, particularly in systems in which the binder does not continue curing after evaporation of the solvent or water.

In order to circumvent this disadvantage, two-component or multi-component systems on an epoxy/amine basis were developed, which make do almost without solvent, so that curing takes place significantly more quickly and furthermore, thicker layers can be applied in one work step, so that the required layer thickness is built up significantly faster. However, these have the disadvantage that the binder forms a very stable and rigid polymer matrix, often with a high plastification range, which hinders foam formation by the foaming agents. For this reason, thick layers must be applied in order to produce sufficient foam thickness for the insulation. This in turn is disadvantageous, because a lot of material is required. In order to make it possible for these systems to be applied, processing temperatures of up to +70° C. are frequently necessary, and this makes use of these systems time-consuming and expensive to install. Furthermore, some of the binder components used are toxic or otherwise critical (e.g. irritating, corrosive), such as, for example, the amines or amine mixtures used in the epoxy/amine systems.

The invention was therefore based on the task of creating an insulation-layer-forming coating system of the type stated initially, which avoids the aforementioned disadvantages, which is particularly not solvent-based or water-based, and demonstrates fast, homogeneous curing, and requires only a slight layer thickness because of the great intumescence, i.e. the formation of an effective ash crust layer.

This task is accomplished by the composition according to claim 1. Preferred embodiments can be derived from the dependent claims.

Accordingly, an object of the invention is an insulation-layer-forming composition having an alkoxysilane-functional polymer, which is terminated and/or contains alkoxy-functional silane groups of the general Formula (I) as side groups along the polymer chain

—Si(R¹)ₘ(OR²)₃₋ₘ (I),

in which R¹ stands for a linear or branched C₁-C₁₆ alkyl radical, preferably for a methyl or ethyl radical, R² stands for a linear or branched C₁-C₆ alkyl radical, and m stands for a whole number from 0 to 2, and having an insulation-layer-forming fire-protection additive.

According to the invention, a polymer is a molecule having six or more repetition units, which can have a structure that can be linear, branched, star-shaped, twisted, hyper-branched or crosslinked. Polymers can have a single type of repetition units (“homopolymers”) or they can have more than one type of repetition units (“copolymers”). As used herein, the term “polymer” comprises both prepolymers, which can also comprise oligomers having 2 to 5 repetition units, such as the alkoxysilane-functional compounds used as polymers, which react with one another in the presence of water, with the formation of Si—O—Si bonds, and also the polymer compounds formed by the reaction just mentioned.

By means of the composition according to the invention, coatings having the layer thickness required for the respective fire-resistance duration can be applied in simple and rapid manner. The advantages that can be achieved by means of the invention can essentially be seen in that in comparison with the systems on a solvent or water basis, with their inherently slow curing times, but also in comparison with a composition according to WO 2010/131037 A1, the work time can be significantly reduced and that no solvent is used. It is furthermore advantageous, particularly as compared with a composition according to WO 2010/131037 A1, that the curing behavior of a composition according to the invention is independent of the relative humidity of the surroundings in which the composition is used.

A further advantage lies in that it is possible to do without substances that represent a health hazard or are subject to labeling, such as critical amine compounds, for example, to a great extent or completely, with the exception of a catalyst that is used in very slight concentrations, if at all.

Because of the lower plastification range of the polymer matrix, as compared with systems on an epoxy/amine basis, the intumescence is relatively high as compared with the expansion rate, so that a great insulating effect can be achieved even with thin layers. The high fill degree of the composition with fire-protection additives, which is possible, also contributes to this. Accordingly, the material expenditure decreases, and this has an advantageous effect on material costs, particularly in the case of application over a large area. This is achieved, in particular, by the use of a reactive system that does not dry physically, but rather cures chemically by hydrolysis and subsequent polycondensation. As a result, only a slight volume loss is recorded, resulting from drying or solvent, or, in the case of water-based systems, of water. For example, in a traditional system, a solvent content of about 25% is typical. This means that of a 10 mm layer, only 7.5 mm remain on the substrate to be protected, as an actual protection layer. In the composition according to the invention, more than 93% of the coating remains on the substrate to be protected.

Compared with solvent-based or water-based systems when they are applied without a primer, the compositions according to the invention demonstrate excellent adhesion to different metallic and non-metallic substrates, as well as excellent cohesion and impact resistance.

For a better understanding of the invention, the following explanations of the terminology used herein are considered useful. In the sense of the invention:
“chemical intumescence” means the formation of a voluminous, insulating ash layer by means of compounds coordinated with one another, which react with one another when acted on by heat;
“physical intumescence” means the formation of a voluminous, insulating layer by means of expansion of a compound that releases gases, without a chemical reaction between two compounds having taken place, thereby causing the volume of the compound to increase by a multiple of the original volume;
“insulation-layer-forming” that in the event of a fire, a firm micro-porous carbon foam is formed, so that the fine-pore and thick foam layer that is formed, called the ash crust, insulates a substrate against heat, depending on the composition;
a “carbon supplier” is an organic compound that leaves a carbon skeleton behind due to incomplete combustion, and does not combust completely to form carbon dioxide and water (carbonization); these compounds are also called “carbon-skeleton-forming agents”;
an “acid-forming agent” is a compound that forms a non-volatile acid under the effect of heat, i.e. above about 150° C., for example by decomposition, and thereby acts as a catalyst for carbonization; furthermore, it can contribute to lowering of the viscosity of the melt of the binder; the term “dehydrogenation catalyst” is used as an equivalent;
a “propellant” is a compound that decomposes at elevated temperature, with the development of inert, i.e. non-combustible gases, and, if applicable, expands the plasticized binder to form a foam (intumescence); this term is used as having the same meaning as “gas-forming agent”;
an “ash-crust stabilizer” is what is called a skeleton-forming compound, which stabilizes the carbon skeleton (ash crust), which is formed from the interaction of the carbon formation from the carbon source and the gas from the propellant, or the physical intumescence. The fundamental method of effect in this regard is that the carbon layers that form, and are actually very soft, are mechanically solidified by inorganic compounds. The addition of such an ash-crust stabilizer contributes to significant stabilization of the intumescence crust in the event of a fire, because these additives increase the mechanical strength of the intumescent layer and/or prevent it from dripping off.

According to the invention, the alkoxysilane-functional polymer comprises a basic skeleton that is selected from the group consisting of an alkyl chain, polyether, polyester, polyether ester, polyamide, polyurethane, polyester urethane, polyether urethane, polyether ester urethane, polyamide urethane, polyurea, polyamine, polycarbonate, polyvinyl ester, polyacrylate, polyolefin, such as polyethylene or polypropylene, polyisobutylene, polysulfide, natural rubber, neoprene, phenolic resin, epoxy resin, melamine. In this regard, the basic skeleton can have a linear or branched structure (linear basic skeleton with side chains along the chain of the basic skeleton) and contains alkoxy-functional silane groups, preferably at least two alkoxy-functional silane groups, in a terminating position, i.e. as the end groups of a linear basic skeleton or as the end groups of the linear basic skeleton and as the end groups of the side groups. Preferably, the basic skeleton consists of polypropylene glycol or polyurethane.

The alkoxy-functional silane group has the general Formula (I)

—Si(R¹)ₘ(OR²)₃₋ₘ (I),

in which R¹ stands for a linear or branched C₁-C₁₆ alkyl radical, preferably for a methyl or ethyl radical, R² stands for a linear or branched C₁-C₆ alkyl radical, preferably for a methyl or ethyl radical, and m stands for a whole number from 0 to 2, preferably 0 or 1.

Preferably, the alkoxy-functional silane group is bound to the basic skeleton by way of a group such as a further, different functional group (X=e.g. —S—, —OR, —NHR, —NR₂), which either itself can function as an electron donor or contains an atom that can function as an electron donor, wherein the two functional groups, i.e. the further functional group and the alkoxy-functional silane group are connected with one another by way of a methylene bridge or a propylene bridge (—X—CH₂—Si(R¹)ₘ(OR²)₃₋ₘ or (—X—C3H6-Si(R¹)ₘ(OR²)₃₋ₘ).

Most preferably, the alkoxysilane-functional polymers are polymers in which the basic skeleton is terminated by way of a urethane group with silane groups, such as, for example di methoxy(methyl)silyl methylcarbamate-terminated polyethers and polyurethanes, dimethoxy(methyl)silylpropylcarbamate-terminated polyethers and polyurethanes, trimethoxysilylmethylcarbamate-terminated polyethers and polyurethanes, trimethoxysilylpropylcarbamate-terminated polyethers and polyurethanes or mixtures thereof.

Examples of suitable polymers comprise silane-terminated polyethers (e.g. Geniosil® STP-E 10, Geniosil® STP-E 15, Geniosil® STP-E 30, Geniosil® STP-E 35, Geniosil® XB 502, Geniosil® WP 1 from Wacker Chemie AG, Polymer ST61, Polymer ST75 and Polymer ST77 from Evonik Hanse), and silane-terminated polyurethanes (Desmoseal® S XP 2458, Desmoseal® S XP 2636, Desmoseal® S XP 2749, Desmoseal® S XP 2821 from Bayer, SPUR+*1050MM, SPUR+*1015LM, SPUR+* 3100HM, SPUR+* 3200HM from Momentive).

The viscosity of these alkoxysilane-functional polymers preferably lies between 0.1 and 50.000 Pa·s, more preferably between 0.5 and 35,000 Pa·s, and most preferably between 0.5 and 30,000 Pa·s.

The viscosity was determined using a Kinexus rotation rheometer, by measuring a flow curve at 23° C.; the values indicated are the measured value at 215 s⁻¹.

As alternative polymers, preferably those in which the alkoxy-functional silane groups are not terminally installed into the skeleton of the polymer but rather distributed, in targeted manner, in side positions over the chain of the basic skeleton, can preferably be used. Important properties, such as the crosslinking density, can be controlled by way of the installed multiple crosslinking units. Here, the product line TEGOPAC® from Evonik Goldschmidt GmbH can be mentioned as a suitable example, such as TEGOPAC BOND 150, TEGOPAC BOND 250 and TEGOPAC SEAL 100. In this connection, reference is made to DE 102008000360 A1, DE 102009028640 A1, DE102010038768 A1, and DE 102010038774 A1 as examples.

Usually, in these alkoxysilane-functional polymers, the polymer carries 2 to 8 alkoxysilane-functional silane groups per prepolymer molecule.

The degree of crosslinking of the binder and thereby both the strength of the resulting coating and its elastic properties can be adjusted as a function of the chain length of the basic skeleton, the alkoxy-functionality of the polymer, and the seat of the alkoxy-functional silane groups.

Usually, the amount of the binder is 5 to 60 wt.-%, preferably 5 to 50 wt.-%, more preferably 10 to 40 wt.-%, with reference to the composition.

According to the invention, the composition contains an insulation-layer-forming fire-protection additive, wherein the additive can comprise both individual compounds and a mixture of multiple compounds.

It is practical if, as an insulation-layer-forming fire-protection additive, an additive is used that acts by means of the formation of an expanded insulating layer that forms under the effect of heat, composed of a material with low flammability, which protects the substrate from overheating and thereby prevents or at least delays a change in the mechanical and static properties of supporting structural parts. The formation of a voluminous insulating layer, namely an ash layer, can be formed by means of the chemical reaction of a mixture of corresponding compounds, coordinated with one another, which react with one another under the effect of heat. Such systems are known to a person skilled in the art by the term chemical intumescence, and can be used according to the invention. Alternatively, the voluminous, insulating layer can be formed by means of physical intumescence. Both systems can be used alone or together, according to the invention, as a combination, in each instance.

For the formation of an intumescent layer by means of chemical intumescence, at least three components are generally required, a carbon supplier, a dehydrogenation catalyst, and a propellant, which are contained in a binder in the case of coatings, for example. Under the effect of heat, the binder plasticizes, and the fire-protection additives are released, so that the react with one another, in the case of chemical intumescence, or can expand, in the case of physical intumescence. The acid that serves as the catalyst for carbonization of the carbon supplier is formed from the dehydrogenation catalyst, by means of thermal decomposition. At the same time, the propellant decomposes, forming inert gases that brings about expansion of the carbonized (charred) material and, if applicable, the plasticized binder, causing the formation of a voluminous, insulating foam.

In an embodiment of the invention in which the insulating layer is formed by means of chemical intumescence, the insulation-layer-forming additive comprises at least one carbon-skeleton-forming agent, if the binder cannot be used as such, at least one acid-forming agent, at least one propellant, and at least one inorganic skeleton-forming agent. The components of the additive are particularly selected in such a manner that they can develop synergy, wherein some of the compounds can fulfill multiple functions.

Compounds usually used in intumescent fire-protection agents and known to a person skilled in the art are possible carbon suppliers, such as compounds similar to starch, for example starch and modified starch, and/or multivalent alcohols (polyols), such as saccharides and polysaccharides and/or a thermoplastic or duroplastic polymer resin binder, such as a phenolic resin, a urea resin, a polyurethane, polyvinyl chloride, poly(meth)acrylate, polyvinyl acetate, polyvinyl alcohol, a silicone resin and/or a natural rubber. Suitable polyols are polyols from the group of sugar, pentaerythrite, dipentaerythrite, tripentaerythrite, polyvinyl acetate, polyvinyl alcohol, sorbitol, EO-PO-polyols. Preferably, pentaerythrite, dipentaerythrite or polyvinyl acetate are used.

It should be mentioned that in the event of a fire, the binder itself can also have the function of a carbon supplier.

Compounds usually used in intumescent fire-protection formulations and known to a person skilled in the art are possible dehydrogenation catalysts or acid-forming agents, such as a salt or an ester of an inorganic, non-volatile acid, selected from among sulfuric acid, phosphoric acid or boric acid. Essentially, compounds containing phosphorus are used; their palette is very large, because they extend over multiple oxidation stages of phosphorus, such as phosphines, phosphine oxides, phosphonium compounds, phosphates, elemental red phosphorus, phosphites, and phosphates. The following examples of phosphoric acid compounds can be mentioned: mono-ammonium phosphate, di-ammonium phosphate, ammonium phosphate, ammonium polyphosphate, melamine phosphate, melamine resin phosphate, potassium phosphate, polyol phosphates such as pentaerythrite phosphate, glycerin phosphate, sorbite phosphate, mannite phosphate, dulcite phosphate, neopentyl glycol phosphate, ethylene glycol phosphate, dipentaerythrite phosphate, and the like. Preferably, a polyphosphate or an ammonium polyphosphate is used as a phosphoric acid compound. In this regard, melamine resin phosphates are understood to be compounds such as the reaction products of Lamelite C (melamine/formaldehyde resin) with phosphoric acid. The following examples of sulfuric acid compounds can be mentioned: ammonium sulfate, ammonium sulfamate, nitroaniline bisulfate, 4-nitroaniline-2-sulfonic acid and 4,4-dinitrosulfanilamide and the like. Melamine borate can be mentioned as an example of a boric acid compound.

Possible propellants are the compounds usually used in fire-protection agents and known to a person skilled in the art, such as cyanuric acid or isocyanic acid and their derivatives, melamine and its derivatives. Such compounds are cyanamide, dicyanamide, dicyandiamide, guanidine and its salts, biguanide, melamine cyanurate, cyanic acid salts, cyanic acid esters and amide, hexamethoxymethyl melamine, dimelamine pyrophosphate, melamine polyphosphate, melamine phosphate. Preferably, hexamethoxymethyl melamine or melamine (cyanuric acid amide) is used.

Furthermore, components that does not restrict their method of action to a single function, such as melamine polyphosphate, which acts both as an acid-forming agent and as a propellant, are suitable. Further examples are described in GB 2 007 689 A1, EP 139 401 A1, and U.S. Pat. No. 3,969,291 A1.

In an embodiment of the invention, in which the insulating layer is formed by means of physical intumescence, the insulation-layer-forming additive comprises at least one thermally expandable compound, such as a graphite intercalation compound, which compounds are also known as expandable graphite. These can also be contained in the binder, particularly homogeneously.

Known intercalation compounds of SOₓ, NOₓ, halogen and/or strong acids in graphite are possible for use as expanded graphite, for example. These are also referred to as graphite salts. Expanded graphites that give off SO₂, SO₃, NO and/or NO₂ at temperatures of 120 to 350° C., for example, causing expansion, are preferred. The expanded graphite can be present, for example, in the form of small plates having a maximal diameter in the range of 0.1 to 5 mm. Preferably, this diameter lies in the range of 0.5 to 3 mm. Expanded graphites suitable for the present invention are commercially available. In general, the expanded graphite particles are uniformly distributed in the fire-protection elements according to the invention. The concentration of expanded graphite particles can, however, also be varied in point-like, pattern-like, planar and/or sandwich-like manner. In this regard, reference is made to EP 1489136 A1, the content of which is hereby incorporated into this application.

In a further embodiment of the invention, the insulating layer is formed both by means of chemical and by means of physical intumescence, so that the insulation-layer-forming additive comprises not only a carbon supplier, a dehydrogenation catalyst, and a propellant, but also thermally expandable compounds.

Because the ash crust formed in the event of a fire is generally too unstable, and, depending on its density and structure, can be blown away by air streams, for example, which has a negative effect on the insulating effect of the coating, preferably at least one ash-crust stabilizer is added to the components just listed.

The compounds usually used in fire-protection formulations and known to a person skilled in the art are usually considered as ash-crust stabilizers or skeleton-forming agents, for example expanded graphite and particulate metals, such as aluminum, magnesium, iron, and zinc. The particulate metal can be present in the form of a powder, of lamellae, scales, fibers, threads and/or whiskers, wherein the particulate metal in the form of powder, lamellae or scales possesses a particle size of ≦50 μm, preferably of 0.5 to 10 μm. In the case of use of the particulate metal in the form of fibers, threads and/or whiskers, a thickness of 0.5 to 10 μm and a length of 10 to 50 μm are preferred. Alternatively or additionally, an oxide or a compound of a metal from the group comprising aluminum, magnesium, iron or zinc can be used as an ash-crust stabilizer, particularly iron oxide, preferably iron trioxide, titanium dioxide, a borate, such as zinc borate and/or a glass frit composed of glass types having a low melting point, with a melting temperature of preferably at or above 400° C., phosphate or sulfate glass types, melamine poly-zinc-sulfates, ferroglass types or calcium boron silicates. The addition of such an ash-crust stabilizer contributes to significant stabilization of the ash crust in the event of a fire, since these additives increase the mechanical strength of the intumescent layer and/or prevent it from dripping off. Examples of such additives are also found in U.S. Pat. No. 4,442,157 A, U.S. Pat. No. 3,562,197 A, GB 755 551 A, as well as EP 138 546 A1.

In addition, ash-crust stabilizers such as melamine phosphate or melamine borate can be contained.

The insulation-layer-forming fire-protection additive can be contained in the composition in an amount of 30 to 99 wt.-%, wherein the amount essentially depends on the application form of the composition (spraying, brushing, and the like). In order to bring about the highest possible intumescence rate, the proportion of the insulation-layer-forming fire-protection additive in the total formulation is set to be as high as possible. Preferably, its proportion in the total formulation amounts to 35 to 85 wt.-%, and particularly preferably 40 to 85 wt.-%.

From WO 2010/131037 A1, a composition is known, which is based on silane-terminated polyurethanes or silane-terminated polyethers as binders, with plasticizers compatible with them, and with intumescent additives. This composition cures by means of moisture. Accordingly, curing of the composition begins at the surface. However, this is disadvantageous in that curing is greatly dependent on relative humidity and on the layer thickness, which generally leads to long curing times or, in a very dry environment, to no curing any longer. It is furthermore disadvantageous that curing is greatly non-homogeneous, and furthermore the crosslinking density can vary greatly.

In a preferred embodiment, the composition therefore contains a crosslinking agent as a further constituent, wherein water is particularly preferred as a crosslinking agent. In this way, more homogeneous and faster curing of the binder can be achieved, compared with a composition according to WO 2010/131037 A1. Curing of the composition therefore becomes independent of the absolute humidity in the air, to a great extent, and the composition cures reliably and quickly, even under extremely dry conditions.

The water content in the composition can amount to as much as 5 wt.-%, with reference to the polymer, wherein a content in the range between 0.1 and 5 wt.-% is preferred, between 0.5 and 3 wt.-% is more preferred, and between 0.6 and 2 wt.-% is even more preferred.

Aside from the actual crosslinking agent, particularly water, the composition can contain further crosslinking agents, other than water. These are referred to as co-crosslinking agents herein. Different properties, such as adhesion to the substrate, better wetting of the additives, and curing speed of the composition can be optimized in targeted manner and customized by means of the co-crosslinking agent.

Suitable co-crosslinking agents are selected from the group of basic silane-functional compounds, for example amino silanes, such as aminopropyltrimethoxysilane, aminopropyltriethoxysilane, aminopropylmethyldimethoxysilane, aminopropylmethyldiethoxysilane, N-(2-aminoethyl)-aminopropyltrimethoxysilane, N-(2-aminoethyl)aminopropyltrimethoxysilane, N-(2-aminoethyl)-aminopropyltriethoxysilane, N-(2-aminoethyl)-aminopropyl-methyldimethoxysilane, N-cyclohexylaminomethyltriethoxysilane, N-cyclohexyl-aminomethyl-methyldiethoxysilane, N-cyclohexylaminomethyl-trimethoxysilane, N-cyclohexylaminomethy-1-methyldimethoxysilane.

These co-crosslinking agents are preferably contained in an amount of 0.05 to 5.0 wt.-%, with reference to the total composition, more preferably of 0.1 to 3.0 wt.-%, and most preferably of 0.5 to 2.0 wt.-%.

In order for the alkoxysilane-functional polymer and the crosslinking agent not to be brought prematurely into contact with one another and curing to be initiated prematurely, it is practical if these are separated from one another, to inhibit a reaction.

In a preferred embodiment, the composition contains at least one catalyst. All compounds that are suitable for catalyzing the formation of the Si—O—Si-bonds between the silane groups of the polymers can be used as catalysts. As examples, metal compounds, such as titanium compounds, tin compounds can be mentioned. Alternatively, acidic or basic catalysts can be mentioned.

Among the titanium compounds, titanate esters are preferred, such as tetrabutyltitanate, tetrapropyltitanate, tetraisopropyltitanate, tetraacetylacetonate-titanate.

Among the metal compounds as catalysts, organo-aluminum compounds or reaction products of bismuth salts or chelate compounds, such as zirconium tetracetylacetonate, can be mentioned.

Among the tin compounds, dibutyl tin dilaurate, dibutyl tin maleate, dibutyl tin diacetate, dibutyl tin dioctanoate, dibutyl tin acetylacetonate, dibutyl tin oxide, or corresponding compounds of dioctyl tin, tin naphthenate, dimethyl tin dineododecanoate, reaction products of dibutyl tin oxide, and phthalic acid esters are preferred.

Since some of these catalysts are problematical with regard to their toxicity, catalysts that do not contain metals, such as acidic or basic catalysts, are preferred.

Phosphoric acid or phosphoric acid esters, toluene sulfonic acids, and mineral acids can be mentioned as examples of acidic catalysts.

Solutions of simple bases such as NaOH, KOH, K₂OO₃, ammonia, Na₂CO₃, aliphatic alcoholates or K-phenolate can be mentioned as examples of basic catalysts.

Particularly preferably, the catalyst is selected from among the group of organic amines, such as triethylamine, tributylamine, trioctylamine, monoethanolamine, diethanolamine, triethanolamine, triisopropanolamine, tetramethylene diamine, Quadrol, diethylene triamine, dimethylaniline, Proton Sponge, N,N′-bis[2-(dimethylamino)ethyl]-N,N′-dimethylethylene diamine, N,N-dimethylcyclohexylamine, N-dimethylphenlyamine, 2-methylpentamethylene diamine, 2-methylpentamethylene diamine, 1,1,3,3-tetramethylguanidine, 1,3-diphenylguanidine, benzamidine, N-ethylmorpholine, 2,4,6-tris(dimethylaminomethyl)phenol (TDMAMP); 1,8-diazabicyclo[5.4.0]undec-7-ene (DBU), and 1,5-diazabicyclo(4.3.0)non-5-ene (DBN); n-pentylamine, n-hexylamine, di-n-propylamine, and ethylene diamine; DABCO, DMAP, PMDETA, imidazol and 1-methylimidazol or salts of amines and carboxylic acids, and polyetheramines, such as polyethermonoamines, polyetherdiamines or polyethertriamines, such as, for example, the Jeffamines of Huntsman and ether amines, such as, for example, the Jeffkats of Huntsman. In this regard, reference is made to the patent applications WO 2011/157562 A1 and WO 2013/003053 A1.

The type and the amount of the catalyst are selected as a function of the selected alkoxysilane-functional polymer and the desired reactivity.

In a further embodiment, the composition according to the invention furthermore contains at least one further constituent, selected from among plasticizers, water catchers, organic and/or inorganic admixtures and/or further additives.

The plasticizer has the task of plasticizing the cured polymer network. Furthermore, the plasticizer has the task of introducing an additional liquid component, so that the fillers are completely wetted and the viscosity is adjusted in such a manner that the coating becomes processable using a spray device. The plasticizer can be contained in the formulation in such an amount that it can sufficiently fulfill the functions just described.

Preferably the plasticizer is selected from among derivatives of benzoic acid, phthalic acid, e.g. phthalates, such as dibutylphthalate, dioctylphthalate, dicyclohexylphthalate, diisooctylphthalate, diisodecylphalate, dibenzylphthalate or butylbenzylphthalate, trimellitic acid, pyromellitic acid, alkane diacid, such as butyric acid, glutaric acid, pimelic acid, adipic acid, suberic acid, azelaic acid, sebacic acid, fumaric acid, maleic acid, itaconic acid, caprylic acid and citric acid, ricinoleic acid, phosphates, alkylphosphate esters, and derivatives of polyesters and polyethers, glycol ethers and glycol esters, epoxy-enhanced oils, sulfonamides, terpenes, oils and derivatives thereof, such as soybean oil, C₁₀-C₂₁ alkylsulfonic acid esters of phenol, alkanes, cycloalkanes, and alkyl esters. More preferably, the plasticizer is selected from an ester derivative of terephthalic acid, a triol ester of caprylic acid, a glycol diester, diol esters of aliphatic dicarboxylic acids, ester derivative of citric acid, secondary alkylsulfonic acid ester, ester derivatives of glycerin with epoxy groups, and ester derivatives of phosphates. Most preferably, the plasticizer is dioctyladipate, bis(2-ethylhexyl)terephthalate, trihydroxymethylpropylcaprylate, triethylene glycol-bis(2-ethylhexanoate), 1,2-cyclohexane dicarboxylic acid diisononyl ester, a mixture of 75-85% secondary alkylsulfonic acid esters, 15-25% secondary alkane disulfonic acid diphenylesters, as well as 2-3% non-sulfonated alkanes, triethylcitrate, epoxy-enhanced soybean oil, tri-2-ethylhexylphosphate or a mixture of n-octylsuccinate and n-decylsuccinate.

Examples of this are Plastomoll DOA, Eastman™ DOTP Plasticizer (Eastman), Esterex NP 343 (Exxon Mobil), Solusolv 2075 (Butvar), Hexamoll DINCH (BASF), Mesamoll II (Lanxess), triethylcitrate (Sigma Aldrich), Paraplex G-60 (Hallstar), Disflammol TOF (Lanxess), and Uniplex LXS TP ODS (Lanxess).

In the composition, the plasticizer can preferably be contained in an amount of 0.1 to 40 wt.-%, more preferably 1 to 35 wt.-%, and even most preferably 5 to 25 wt.-%, with reference to the total composition.

In order to prevent a premature reaction with residual moisture of the fillers used or of the humidity in the air, water catchers are usually added to the composition. Preferably, the water catcher is an organo-functional alkoxysilane or an oligomer organo-functional alkoxysilane, more preferably a vinyl-functional silane, an oligomer vinyl-functional silane, a vinyl-/alkyl-functional silane, an oligomer amino-/alkyl-functional silane, an acetoxy-/alkyl-functional silane, an amino-functional silane, an oligomer amino-functional silane, a carbamatosilane or a methacryloxy-functional silane. Most preferably, the water catcher is di-tert-butoxydiacetoxysilane, bis(3-triethoxysilylpropyl)amine, bis(3-trimethoxypropyl)amine, 3-aminopropylmethyldiethoxysilane, 3-aminopropyltriethoxysilane, vinyl triethoxysilane, vinyl trimethoxysilane, vinyl tris(2-methoxyethoxy)silane, N-cyclohexylaminomethyl triethoxysilane, vinyldimethoxymethyl silane, vinyltriacetoxysilane, 3-methacryloxypropyl trimethoxysilane, methacryloxymethyl-methyldimethoxysilane, methacryloxymethyl trimethoxysilane, 3-methacryloxypropyl triacetoxysilane, N-methyl[3-(trimethoxysilyl)propyl]carbamate, N-trimethoxysilylmethyl-O-methylcarbamate, N-dimethoxy(methyl)silyl-methyl-O-methylcarbamate or combinations thereof.

Examples of this are Dynasylan 1146, Dynasylan 6490, Dynasylan 6498, Dynasylan BDAC, Dynasylan 1122, Dynasylan 1124, Dynasylan 1133, Dynasylan 1204, Dynasylan 1505, Dynasylan 1506, Dynasylan AMEO, Dynasylan AMEO-T, Dynasylan VTEO, Dynasylan VTMO, Dynasylan VTMOEO, Dynasylan 6598 (Evonik), Geniosil XL 926, Geniosil XL 10, Geniosil XL 12, Geniosil GF 56, Geniosil GF 62, Geniosil GF 31, Geniosil XL 32, Geniosil XL 33, Geniosil GF 39, Geniosil GF 60, Geniosil XL 63, and Geniosil XL 65 (Wacker).

These water catchers are preferably contained in an amount of 0 to 5 wt.-%, with reference to the total composition, more preferably of 0.5 to 4 wt.-%, and most preferably of 0.7 to 3 wt.-%.

Optionally, one or more reactive flame inhibitors can be added to the composition according to the invention as further additives. Such compounds are built into the binder. Examples in the sense of the invention are reactive organophosphorus compounds, such as 9,10-dihydro-9-oxa-10-phosphaphene-anthrene-10-oxide (DOPO) and its derivatives, such as, for example, DOPO-HQ, DOPO-NQ, and adducts. Such compounds are described, for example, in S. V. Levchik, E. D. Weil, Polym. Int. 2004, 53, 1901-1929.

Additional additives, such as thickeners and/or rheology additives, as well as fillers, can be added to the composition. Preferably, polyhydroxycarboxylic acid amides, urea derivatives, salts of unsaturated carboxylic acid esters, alkylammonium salts of acidic phosphoric acid derivatives, ketoximes, amine salts of p-toluene sulfonic acid, amine salts of sulfonic acid derivatives, as well as aqueous or organic solutions or mixtures of the compounds are used as rheology additives, such as anti-settling agents, anti-runoff agents, and thixotropic agents. In addition, rheology additives on the basis of pyrogenic or precipitated silicic acids or on the basis of silanated pyrogenic or precipitated silicic acids can be used. Preferably, the rheology additives are pyrogenic silicic acids, modified and non-modified sheet silicates, precipitation silicic acids, cellulose ethers, polysaccharides, PU and acrylate thickeners, urea derivatives, castor oil derivatives, polyamides and fatty acid amides and polyolefins, if they are present in solid form, powdered celluloses and/or suspension agents such as xanthan gum, for example.

Aside from the additives already described, the composition can contain usual aids such as wetting agents, for example on the basis of polyacrylates and/or polyphosphates, defoamers, such as silicone defoamers, pigments, fungicides, or diverse fillers, such as vermiculite, inorganic fibers, quarts sand, micro-glass beads, mica, silicon dioxide, mineral wool, and the like, if necessary.

The composition according to the invention can be packaged as a single-component or multi-component system. If the composition contains water as a crosslinking agent or a crosslinking agent that contains water, these must be stored away from the alkoxysilane-functional polymer, so as to inhibit a reaction. Accordingly, such a system is packaged as a two-component or multi-component system.

The further constituents of the composition are divided up in accordance with their compatibility with one another and with the compounds contained in the composition, and can be contained in one of the two components or in both components. It is practical if the water catcher and the co-crosslinking agent, if present, are packaged separately from the component that contains the crosslinking agent, particularly water.

Furthermore, the division of the further constituents, particularly of the solid constituents, can depend on the amounts in which these are supposed to be contained in the composition. By means of a corresponding division, a higher proportion, with reference to the total composition, can occur in some cases.

It is also possible that a component contains merely the crosslinking agent, particularly the water. Alternatively, the crosslinking agent, particularly the water, can be contained in a component of the two-component system together with other constituents, such as plasticizers, additives and/or fillers.

In this regard, the insulation-layer-forming fire-protection additive can be contained as a total mixture or, divided up into individual components, in one component or multiple components. The division of the fire-protection additive takes place as a function of the compatibility of the compounds contained in the composition, so that neither a reaction of the compounds contained in the composition with one another or reciprocal disruption, nor a reaction of these compounds with the compounds of the other constituents can take place. This is dependent on the compounds used.

It is preferred if the insulation-layer-forming fire-protection additive contains a carbon supplier, a propellant, and a dehydrogenation catalyst, the carbon supplier, the propellant, and the dehydrogenation catalyst being divided up among the two components in such a manner that these compounds (individual constituents of the insulation-layer-forming fire-protection additive) and the other constituents of the composition, i.e. the alkoxysilane-functional polymer and the crosslinking agent, are separated from one another, inhibiting a reaction. In this way, it is ensured that the highest possible proportion of fillers can be achieved. This leads to high intumescence, even at low layer thicknesses of the composition.

If the composition furthermore contains an ash-crust stabilizer, the latter can be contained in one of the two components of the two-component system. Alternatively, the ash-crust stabilizer can also be divided up among the two components. Accordingly, the ash-crust stabilizer is divided up among the first component and the second component in such a manner that the first component or the second component contains at least a part of the ash-crust stabilizer, and the second component or the first component contains a further part of the ash-crust stabilizer, if applicable.

The composition is applied to the substrate, particularly metallic substrate, as a paste, using a brush, a roller or by means of spraying. Preferably, the composition is applied by means of an airless spraying method.

The composition according to the invention is characterized, compared with the solvent-based and water-based systems and the system according to WO 2010/131037 A1, by relatively rapid curing by means of hydrolysis and a subsequent polycondensation reaction, thereby making physical drying unnecessary. Furthermore, the curing properties and the properties of the dried (cured) composition can be controlled by way of the water content in the composition. This is particularly very important if the coated structural parts must quickly be subjected to stress or processed further, whether by means of coating with a cover layer or movement or transportation of the parts. Also, the coating is therefore clearly less susceptible to external influences at the construction site, such as, for example, impact of (rain) water or dust and dirt, which can lead, in solvent-based or water-based systems, to water-soluble constituents, such as ammonium polyphosphate, being washed out, or, in the event of dust being absorbed, to reduced intumescence. Because of the low plastification point of the binder and the high solids proportion, the expansion rate under heat effect is high, even at a low layer thickness.

For this reason, the two-component or multi-component composition according to the invention is suitable as a coating, particularly a fire-protection coating, preferably a sprayable coating for substrates on a metallic and non-metallic basis. The substrates are not restricted and comprise structural parts, particularly steel structural parts and wooden structural parts, but also individual cables, cable bundles, cable runs, and cable ducts or other lines.

The composition according to the invention is used, above all, in the construction sector, as a coating, particularly a fire-protection coating for steel construction elements, but also for construction elements composed of other materials, such as concrete or wood, and also as a fire-protection coating for individual cables, cable bundles, cable runs, and cable ducts or other lines.

A further object of the invention is therefore the use of the composition according to the invention as a coating, particularly as a coating for construction elements or structural elements composed of steel, concrete, wood, and other materials, such as plastics, particularly as a fire-protection coating.

The present invention also relates to objects that are obtained when the composition according to the invention has cured. The objects have excellent insulation-layer-forming properties.

The following examples serve for a further explanation of the invention.

### EXEMPLARY EMBODIMENTS

For the production of insulation-layer-forming compositions according to the invention, the following listed constituents are used. The individual components are mixed and homogenized using a dissolver, in each instance. For use, these mixtures are then mixed either before spraying or preferably during spraying, and applied.

In each instance, the curing behavior of the composition was observed; subsequently, the intumescence factor and the relative ash-crust stability were determined. For this purpose, the masses were placed, in each instance, into a round Teflon mold having a depth of about 2 mm and a diameter of 48 mm. The samples were cured at a temperature of +23° C. and a relative humidity of 35%.

To determine the intumescence factor and the relative ash-crust stability, a muffle furnace was preheated to 600° C. A multiple measurement of the sample thickness was conducted using a caliper, and the average value h_{M} was calculated. Then the samples were introduced into a cylindrical steel mold, in each instance, and heated in the muffle furnace for 30 min. After cooling to room temperature, the foam height h_{E1} was first determined in destruction-free manner (average of a multiple measurement). The intumescence factor I is calculated as follows:

Intumescence factor I: I=h_{E1}:h_{M}

Subsequently, a defined weight (m=105 g) was dropped onto the foam from a defined height (h=100 mm) in the cylindrical steel mold, and after this partially destructive effect, the remaining foam height h_{E2} was determined. The relative ash-crust stability was calculated as follows:

Relative ash-crust stability (AKS): AKS=h_{E2}:h_{E1}

For the comparative example and the following Examples 1 to 3, the following formulation was produced as an insulation-layer-forming fire-protection additive, and the mixture was used in the amount indicated, in each instance:

### Insulation-Layer-Forming Fire-Protection Additive

| Compounds | Amount [g] |
|---|---|
| Pentaerythrite | 8.7 |
| Melamine | 8.7 |
| Ammonium polyphosphate | 16.6 |
| Titanium dioxide | 7.9 |

### Comparative Example 1

A commercial fire-protection product based on an aqueous dispersion technology (Hilti CFP S-WB) served as a comparative example.

### Comparative Example 2

A standard epoxy/amine system (Jeffamin® T-403, liquid, solvent-free and crystallization-stable epoxy resin, consisting of low-molecular epoxy resins on the basis of Bisphenol A and Bisphenol F (Epilox® AF 18-30, Leuna-Harze GmbH) and 1,6-hexane dioldiglycidyl ether), which is filled at 60% with an intumescence mixture analogous to the above examples, was tested as a further comparative example.

### Comparative Example 3

A standard epoxy/amine system (isophorone diamine, trimethylolpropane triacrylate, and liquid, solvent-free and crystallization-stable epoxy resin, consisting of low-molecular epoxy resins on the basis of Bisphenol A and Bisphenol F (Epilox® AF 18-30, Leuna-Harze GmbH)), which is filled at 60% with an intumescence mixture analogous to the above examples, was tested served as a further comparative example.

### Example 1

### Constituents

| Compounds | Amount [g] |
|---|---|
| Silane-terminated prepolymer ¹ | 10.9 |
| Vinyl trimethoxysilane ² | 0.5 |
| Aminopropyl triethoxysilane ³ | 0.1 |
| Dioctyl tin dilaurate ⁴ | 0.1 |
| Water | 0.2 |

¹ Desmoseal S XP 2749
² Geniosil ® XL 10
³ Dynasylan ® AMEO
⁴ TIB KAT 216

### Insulation-Layer-Forming Fire-Protection Additive

| Compounds | Amount [g] |
|---|---|
| as indicated above | 18.2 |

### Example 2

### Constituent A

| Compounds | Amount [g] |
|---|---|
| Silane-terminated polyether ⁵ | 16.1 |
| Vinyl trimethoxysilane ⁶ | 0.7 |
| Aminopropyl triethoxysilane ⁷ | 0.5 |
| Plasticizer ⁸ | 2.5 |
| 1,8-diazabicyclo[5.4.0]undec-7-ene | 0.05 |
| N,N′-dibutyl urea | |
| Water | 0.2 |

⁵ GENIOSIL ®STP-E 10
⁶ Geniosil ® XL 10
⁷ Dynasylan ® AMEO
⁸ Mesamoll II

### Insulation-Layer-Forming Additive

| Compounds | Amount [g] |
|---|---|
| as indicated above | 30.0 |

### Example 3

### Constituent A

| Compounds | Amount [g] |
|---|---|
| Silane-terminated polymer ⁹ | 16.0 |
| Vinyl trimethoxysilane ¹⁰ | 0.7 |
| Aminopropyl triethoxysilane ¹¹ | 0.5 |
| 1,8-diazabicyclo[5.4.0]undec-7- | 0.2 |
| ene N,N′-dibutyl urea | |
| Water | 0.2 |

⁹ Desmoseal S XP 2749
¹⁰ Geniosil ® XL 10
¹¹ Dynasylan ® AMEO

### Insulation-Layer-Forming Additive

| Compounds | Amount [g] |
|---|---|
| as indicated above | 30.0 |

TABLE 1
Results of the measurements of the intumescence
factor and of the ash-crust stability

| | Intumescence | Relative | Sample |
|---|---|---|---|
| | factor I | ash-crust stability | thickness |
| Example | (multiple) | AKS (multiple) | h_{M} (mm) |
| 1 | 7.0 | 0.74 | 3.9 |
| 2 | 12 | 0.83 | 3.8 |
| 3 | 14 | 0.52 | 2.8 |
| Comparative | 36 | 0.62 | 1.8 |
| example 1 | | | |
| Comparative | 22 | 0.04 | 1.6 |
| example 2 | | | |
| Comparative | 1.7 | 0.60 | 1.2 |
| example 3 | | | |

1. An insulation-layer-forming composition, comprising:
a) an alkoxysilane-functional polymer, which contains an alkoxy-functional silane group having the general Formula (I), terminated and/or as side group along the polymer chain,
—Si(R¹)ₘ(OR²)₃₋ₘ (I),
in which R¹ stands for a linear or branched C₁-C₁₆ alkyl radical, R² stands for a linear or branched C₁-C₆ alkyl radical, and m stands for a whole number from 0 to 2; and
b) an insulation-layer-forming fire-protection additive.

2. The composition according to claim 1, wherein the polymer comprises a basic skeleton, which is at least one member selected from the group consisting of an alkyl chain, a polyether, polyester, polyether ester, polyamide, polyurethane, polyester urethane, polyether urethane, polyether ester urethane, polyamide urethane, polyurea, polyamine, polycarbonate, polyvinyl ester, polyacrylate, polyolefin, polyisobutylene, polysulfide, natural rubber, neoprene, phenolic resin, epoxy resin, and melamine.

3. The composition according to claim 1, wherein the alkoxysilane-functional polymer contains at least 2 alkoxy-functional silane groups.

4. The composition according to claim 1, wherein the insulation-layer-forming fire-protection additive comprises a mixture of
i) at least one dehydrogenation catalyst, at least one propellant, and
ii) optionally, at least one carbon supplier, or at least one thermally expandable compound or a mixture thereof.

5. The composition according to claim 4, wherein the fire-protection additive further comprises an ash-crust stabilizer.

6. The composition according to claim 1, further comprising at least one crosslinking agent.

7. The composition according to claim 6, wherein the crosslinking agent is water.

8. The composition according to claim 6, wherein the crosslinking agent is separated from the alkoxysilane-functional polymer, thereby inhibiting a reaction between the crosslinking agent and the alkoxysilane functional polymer.

9. The composition according to claim 6, further comprising a co-crosslinking agent.

10. The composition according to claim 1, further comprising a catalyst.

11. The composition according to claim 10, wherein the catalyst is at least one member selected from the group consisting of metal compounds, acidic compounds and basic compounds.

12. The composition according to claim 10, wherein the catalyst is at least one member selected from the group consisting of amine compounds.

13. The composition according to claim 1, further comprising at least one further constituent selected from the group consisting of plasticizers, water catchers, inorganic fillers and further additives.

14. The composition according to claim 1, wherein the composition is packaged as a two-component or multi-component system.

15. A coating, comprising:
the composition according to claim 1.

16. A method for coating of a surface, said method comprising:
contacting said surface with the composition according to claim 1.

17. The coating according to claim 15 which is a fire-protection layer.

18. A cured object, obtained by curing the composition according to claim 1.

19. The method according to claim 16, wherein said surface is a surface of a steel construction element.

20. The method according to claim 16, wherein said surface is a surface of a non-metallic structural part.

21. The composition according to claim 1, wherein the insulation-layer-forming fire-protection additive comprises a mixture of
at least one dehydrogenation catalyst and at least one propellant.

22. The composition according to claim 1, wherein the insulation-layer-forming fire-protection additive comprises
at least one carbon supplier.

23. The composition according to claim 1, wherein the insulation-layer-forming fire-protection additive comprises
at least one thermally expandable compound.

24. The composition according to claim 1, wherein the insulation-layer-forming fire-protection additive comprises a mixture of
at least one dehydrogenation catalyst, at least one propellant, and at least one carbon supplier.

25. The composition according to claim 1, wherein the insulation-layer-forming fire-protection additive comprises a mixture of
at least one dehydrogenation catalyst, at least one propellant, and at least one thermally expandable compound.

26. The composition according to claim 1, wherein the insulation-layer-forming fire-protection additive comprises a mixture of
at least one dehydrogenation catalyst, at least one propellant, at least one carbon supplier, and at least one thermally expandable compound.
